(19) United States
(12) Patent Application Publication
(10) Pub. No.: US 2018/0358764 A1
(43) Pub. Date: Dec. 13, 2018

(54) RJ45 Shuttered Jacks and Related Communication Systems

(71) Applicant: Panduit Corp., Tinley Park, IL (US)

(72) Inventors: Roman J. Churnovic, Joliet, IL (US); Robert E. Fransen, Orland Park, IL (US)

(73) Assignee: Panduit Corp., Tinley Park, IL (US)

(21) Appl. No.: 15/780,325

(22) PCT Filed: Dec. 5, 2016
(86) PCT No.: PCT/US2016/064895

§ 371 Date: May 31, 2018

Related U.S. Application Data
(60) Provisional application No. 62/264,405, filed on Dec. 8, 2015.

(51) Int. Cl. H01R 24/64; H01R 13/453; H01R 13/52; H01R 13/6582

(52) U.S. Cl. CPC H01R 24/64; H01R 13/6582; H01R 13/5213; H01R 13/4536

(57) ABSTRACT

Certain embodiments of the present invention provide an RJ45 jack that has a self-closing shutter door and allows for RJ45 plug insertion in one linear motion, but which incorporates a free contact plug stop on the shutter door and a door catch feature that aids in the retention of the door in the housing when a plug is subjected to a pull out force while latched into the jack.

### FIELD OF INVENTION

The present invention relates to network communications, and more particularly, RJ45 shuttered jacks and related communication systems.

### BACKGROUND

RJ45 is a preferred standard of network communication. Therefore, there is a need for RJ45 jacks and related communication systems.

Shuttered jacks are also desirable, as a shutter door protects internal jack components from external contaminants, such as dust and other debris. However, existing RJ45 shuttered jacks, such as Panduit's MINI-COM® Shuttered Jack Modules, require two motions for RJ45 plug insertion—one to open the shutter door and one to insert the plug. Therefore, there is a need for RJ45 shuttered jacks and related communication systems, and more particularly, RJ45 shuttered jacks and related communication systems that require one motion for RJ45 plug insertion.

Additionally, the International Electrotechnical Commission (“IEC”) has established certain standards for RJ45 connectors. For example, IEC 60603-7 requires that RJ45 connectors include free contact plug stops. Additionally, IEC 60603-7 AP2.2 requires that RJ45 connectors withstand 50N (111 bf) for 60 s±5 s at a maximum load rate of 44.5N/s (101 bf/s). Therefore, there is a need for RJ45 shuttered jacks and related communication systems that comply with these standards.

### SUMMARY

Certain embodiments of the present invention provide an RJ45 jack that has a self-closing shutter door and allows for RJ45 plug insertion in one linear motion, but which incorporates a free contact plug stop on the shutterdoor and a door catch feature that aids in the retention of the door in the housing when a plug is subjected to a pull out force while latched into the jack.

These and other features, aspects, and advantages of the present invention will become better understood with reference to the following drawings, description, and any claims that may follow.

### BRIEF DESCRIPTION OF THE DRAWINGS

FIG. 1 is a perspective view of a communication system according to an embodiment of the present invention;

FIG. 2 is a perspective view of a jack according to an embodiment of the present invention;

FIG. 3 is an exploded view of the jack of FIG. 2;

FIG. 4 is a perspective view of a jack housing from the jack of FIG. 2;

FIG. 5 is a perspective view of a shutter door from the jack of FIG. 2;

FIG. 6 is a side view of the shutter door of FIG. 2;

FIG. 7 is a cross-sectional view taken along line 7-7 of FIG. 1;

FIG. 8 is a cross-sectional view taken along line 8-8 of FIG. 2;

FIG. 9 is a detailed view of a slotted boss from the jack housing of FIG. 4;

FIG. 10 is a perspective view of a jack according to an alternative embodiment of the present invention; and

FIG. 11 is a perspective view of a jack housing from the jack of FIG. 10.

### DETAILED DESCRIPTION

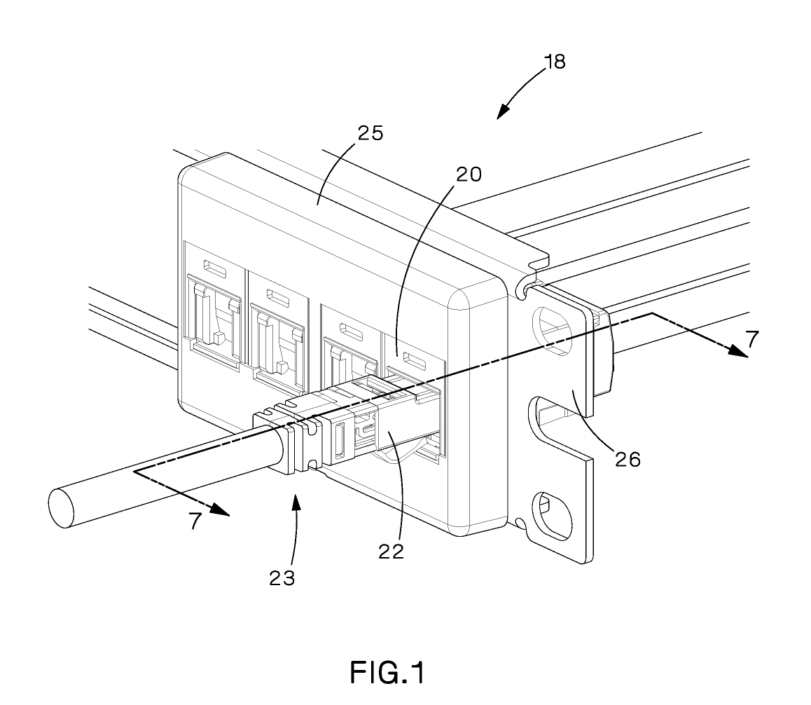

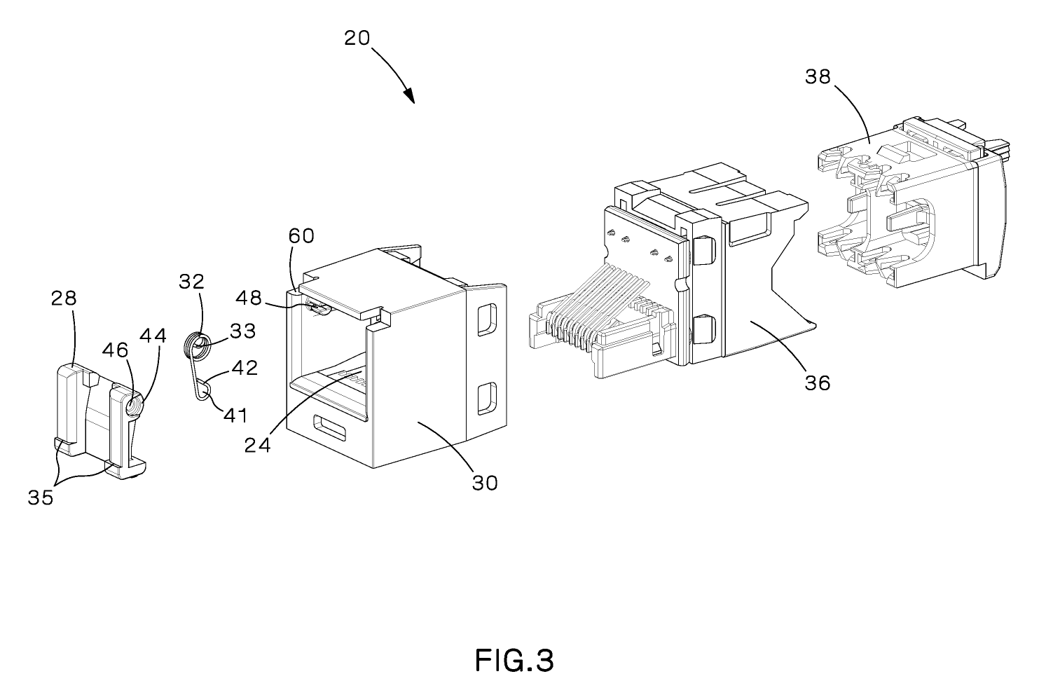

Referring to FIG. 1, communication system 18 includes UTP RJ45 shuttered jacks 20 installed in insert 25 of patch panel 26. One UTP RJ45 shuttered jack 20 is in its mated state with plug 22 of patch cord 23 in jack opening 24 (FIG. 3). The other UTP RJ45 shuttered jacks 20 are in a quiescent state.

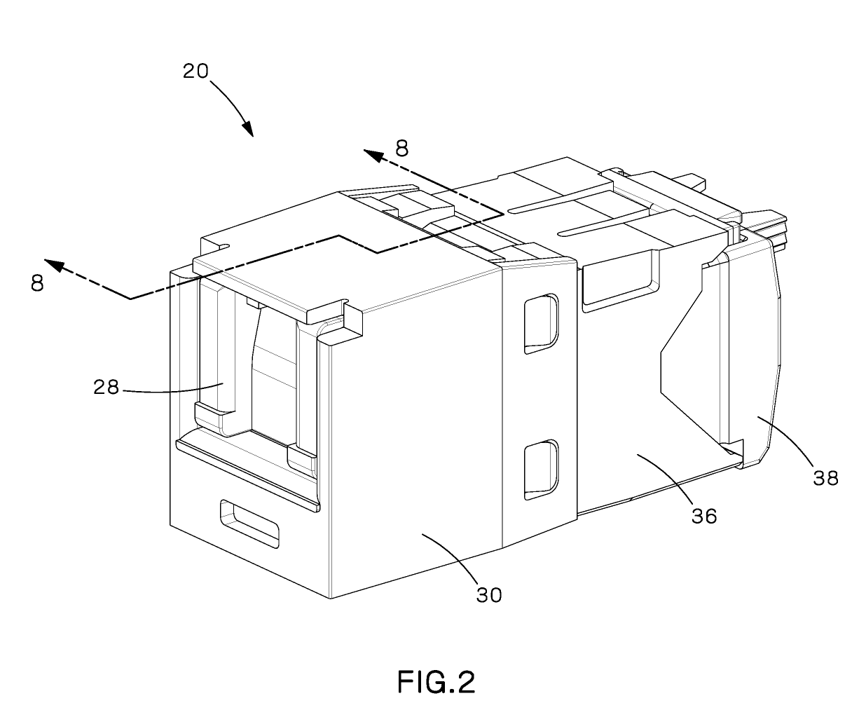

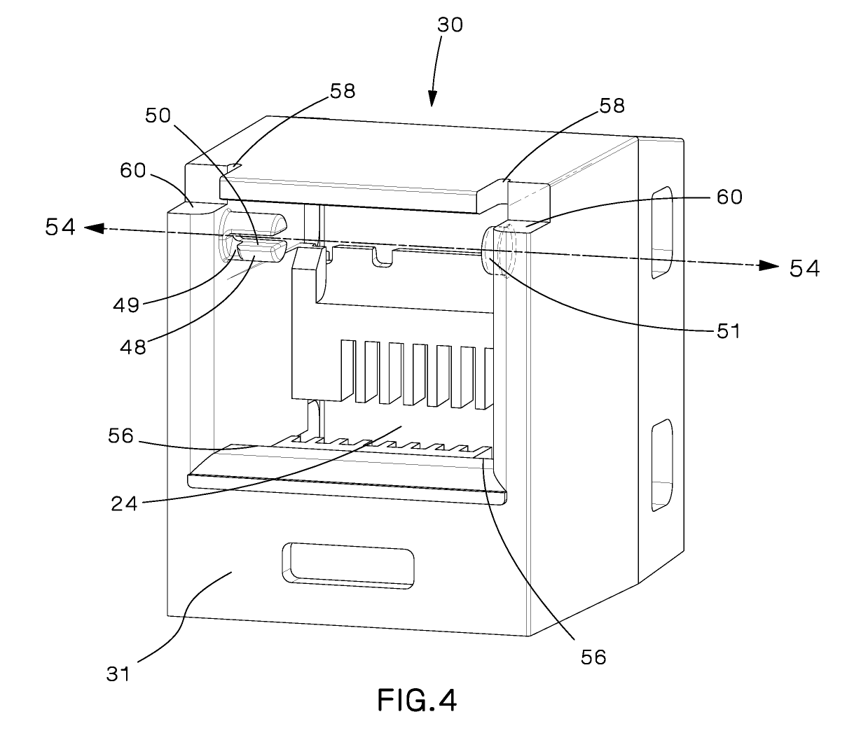

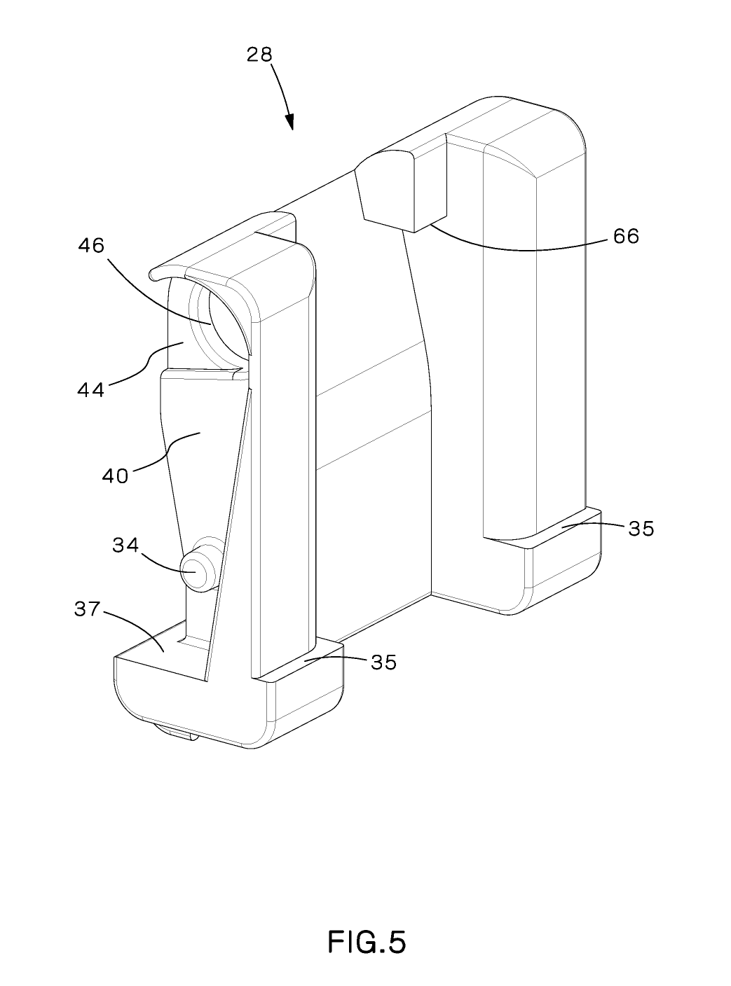

Referring to FIGS. 2 and 3, UTP RJ45 shuttered jack 20 includes shutter door 28, spring 32, shuttered jack housing 30, rear sled assembly 36, and wire cap 38. During assembly, diagonal cross leg 33 of spring 32 is inserted into horizontal slot 50 (FIG. 4) of slotted boss 48 on shuttered jack housing 30. Diagonal cross leg 33 then turns and locks into diagonal slot feature 49 of slotted boss 48. Revolute joint pocket 46 (FIG. 5) of shutter door 28 locks onto slotted boss 48 and solid boss 51 of shuttered jack housing 30 after spring 32 has been assembled to shuttered jack housing 30. To ease assembly, loop 41 on the end of spring leg 42 is captured by boss feature 34 on shutter door 28, which helps position spring 32 into pocket 40 on shutter door 28. Recessed plane 44 on shutter door 28 helps ease assembly by allowing slotted boss 48 and solid boss 51 on shuttered jack housing 30 to slide into revolute joint pocket 46 of shutter door 28.

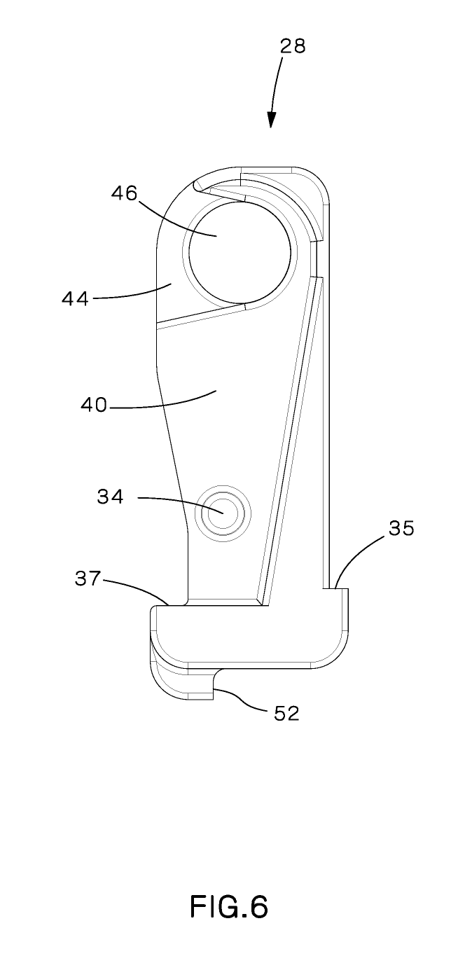

Referring to FIGS. 4-6 and 8, door stops 52 on shutter door 28 prevent shutter door 28 from swinging past the vertical flat plane 31 on shuttered jack housing 30 by contacting inside front edge 56 on shuttered jack housing 30. When installed, shutter door 28 will rotate 90 degrees inward about axis 54, when contacted by plug 22. Relief slots 58 allow deflection of sidewalls 60 when revolute joint pocket 46 of shutter door 8 is assembled onto slatted boss 48 and solid boss 51 of shuttered jack housing 30.

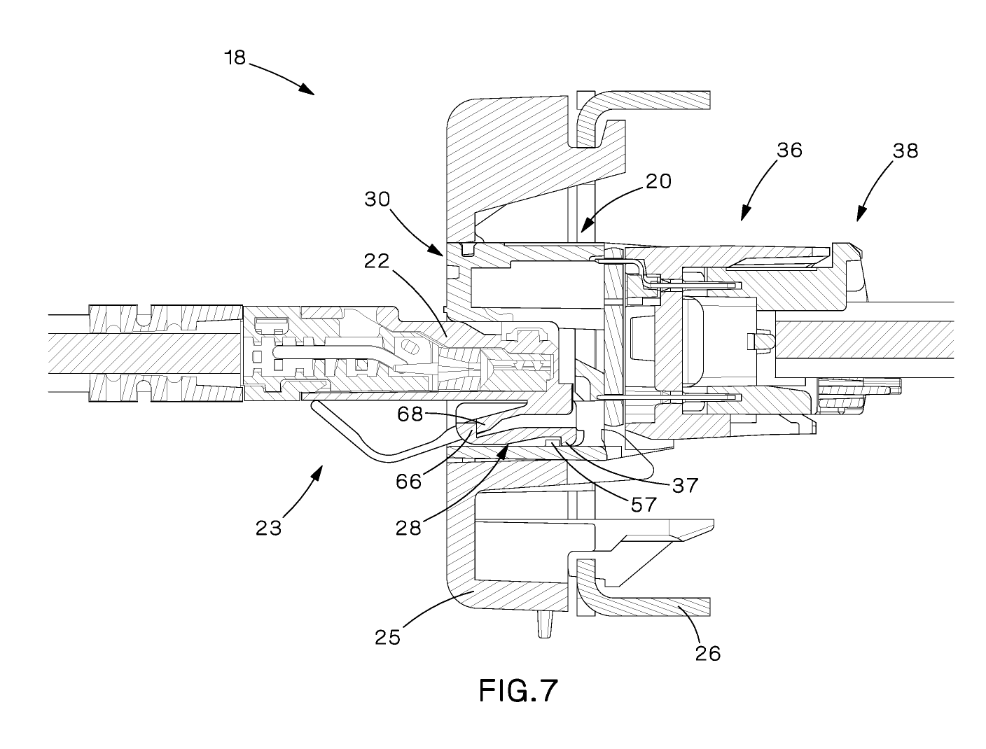

Referring to FIG. 7, plug latch stop 66 on shutter door 28 engages with latches 68 on plug 22, which secures plug 22 to UTP RJ45 shuttered jack 20 during assembly. When plug 22 is fully inserted into UTP RJ45 shuttered jack 20, free contact plug stop 35 (FIG. 5) on shutter door 28 limits the over-travel of plug 22 inside shuttered jack housing 30, meeting the IEC 60603-7 requirement. Retention ledge 37 on shutter door 28 captures retention block 57 of shuttered jack housing 30 when plug 22 is inserted. If plug 22 were to be subjected to a force in the direction of removal while latched to UTP RJ145 shuttered jack 20, retention ledge 37 on shutter door 28 would engage retention block 57 of shuttered jack housing 30, providing additional retention force and removing some of the force seen on slotted boss 48 and solid boss 51 of shuttered jack housing 30. By transferring a significant amount of this pulling force to retention block 57 and away from slotted boss 48 and solid boss 51. UTP RJ45 shuttered jack 20 is more effective at retaining patch cord 23 under tensile loads as well as meeting the IEC 60603-7 AP2.2 requirement.

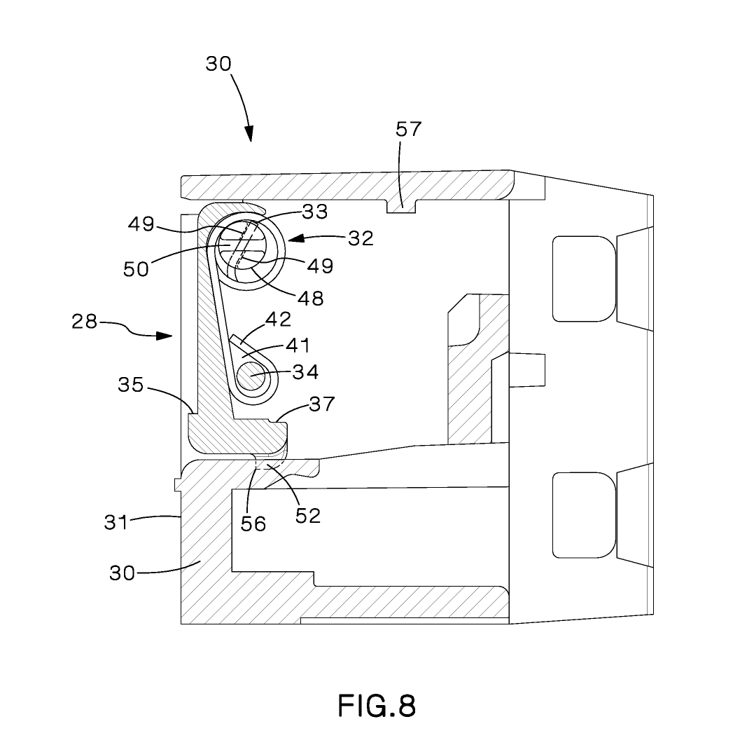

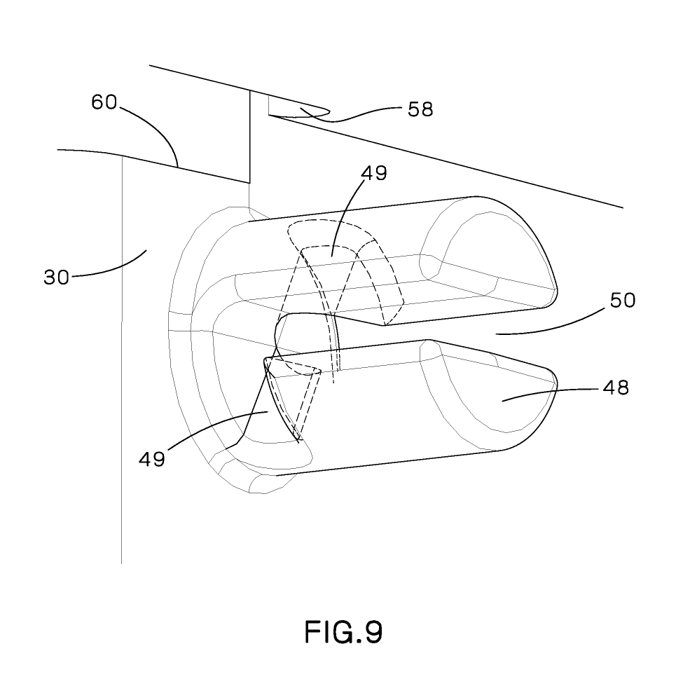

Referring to FIGS. 8 and 9, as shutter door 28 is installed into shuttered jack housing 30, diagonal cross leg 33 of spring 32 engages in diagonal slot feature 49 of slotted boss 48.

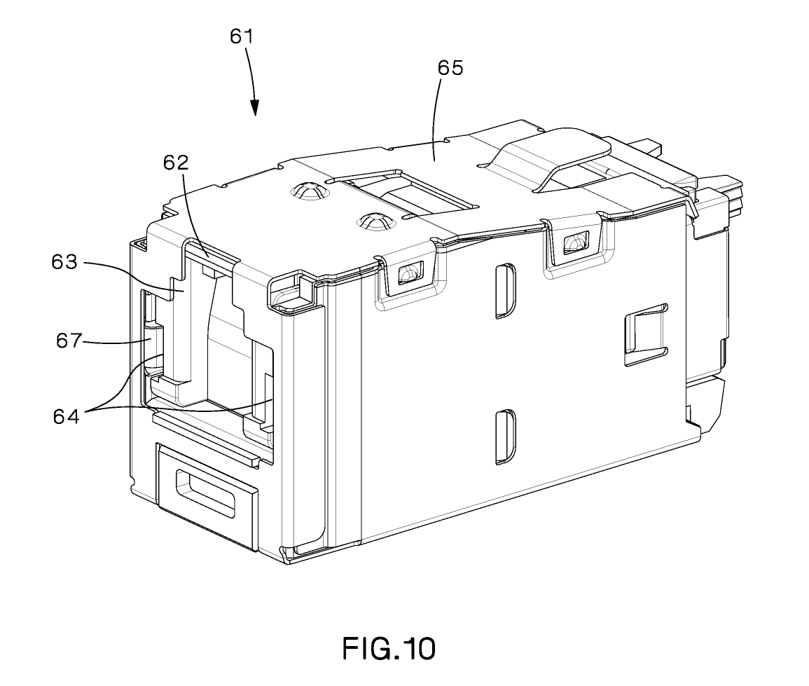

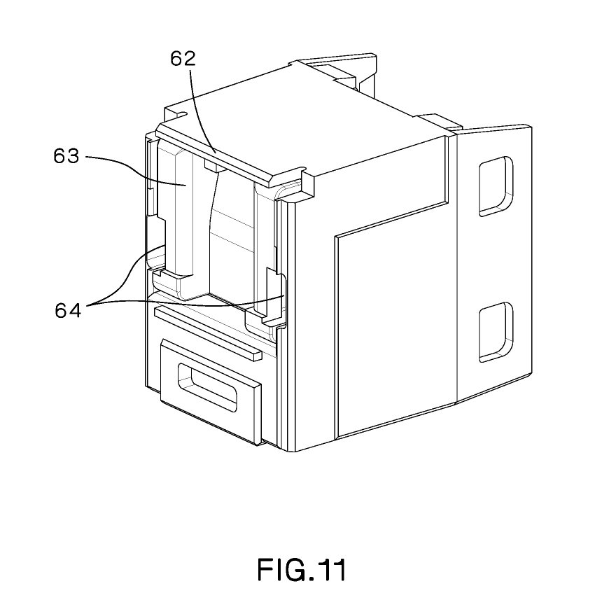

Referring to FIGS. 10 and 11, STP RJ45 shuttered jack 61, shown in a quiescent state, is similar to UTP RJ45 shuttered jack 20 (FIG. 2), except that STP RJ45 shuttered jack 61 includes shielded shuttered jack housing 62, shielded shutter door 63, and jack shield 65. Shielded shuttered jack housing 62 is similar to shuttered jack housing 30 (FIG. 4), except that shielded shuttered jack housing 62 accommodates jack shield 65. Shielded shutter door 63 is similar to shutter door 28 (FIG. 5), except that shielded shutter door 63 includes side cutouts 64, which allow for clearance of plug shield tabs 67 on jack shield 65.

Certain embodiments of the present invention provide an RJ45 jack that has a self-closing shutter door and allows for RJ45 plug insertion in one linear motion, but which incorporates a free contact plug stop on the shutter door and a door catch feature that aids in the retention of the door in the housing when a plug is subjected to a pull out force while latched into the jack.

Certain embodiments of the present invention can be applied in any of CAT5E, CAT6, CAT6A, and other applications, including other jacks.

Certain embodiments of the present invention can include other elements of existing jacks, such as a jack subassembly having a front housing, a front sled assembly with or without a flexible circuit board, a rigid circuit board including compensation, and insulation displacement contacts connected to the rigid board and routed through the rear housing.

Certain embodiment of the present invention can include other elements of the jacks disclosed in U.S. Pat. No. 6,869,297, which is incorporated by reference in its entirety.

Certain embodiment of the present invention can include other elements of the jacks disclosed in U.S. Pat. No. 7,281,957, which is incorporated by reference in its entirety.

Certain embodiments of the present invention can be used in patch panels, faceplates, adapter inserts, surface mount boxes, and any other applications for which a regular TG jack may be utilized.

While this invention has been described in terms of several embodiments, these embodiments are non-limiting (regardless of whether they have been labeled as exemplary or not), and there are alterations, permutations, and equivalents, which fall within the scope of this invention. Additionally, the described embodiments should not be interpreted as mutually exclusive, and should instead be understood as potentially combinable if such combinations are permissive. Moreover, any methods described or claimed, or that may be claimed should not be limited to any specific sequence of steps, and instead should be understood to encompass any sequence if such a sequence is allowable. It should also be noted that there are many alternative ways of implementing the methods and apparatuses of the present invention. It is therefore intended that claims that may follow be interpreted as including all such alterations, permutations, and equivalents as fall within the true spirit and scope of the present invention.

We claim:

1. An RJ45 communications jack 20 comprising:
a housing 30 having revolute joint features 48, 51 and a retention block 57;
a rotatable shutter door 28 with integral plug latch stops 66, revolute, joint features 46 and a retention ledge 37;
wherein upon rotation of the shutter door 28 about the revolute joint features 46, 48, 51, the retention ledge 37 engages the retention block 57 so that when loads are applied to the plug latch stops 66, these loads are transferred to the housing 30 via the retention block 57 and not the revolute joint features 48, 51.

2. The RJ45 communications jack of claim wherein the housing 30 further comprises relief slots 58.

3. The RJ45 communications jack of claim 2 wherein the rotatable shutter door 28 further comprises a recessed plane 44.

4. An RJ45 communications jack 20 comprising:
a housing 30 having is revolute joint feature 48;
a spring 32 that engages the revolute joint feature 48;
wherein the revolute joint feature 48 contains a primary slot 50 for receiving the spring 32; and
wherein the revolute joint feature 48 contains a secondary slot 49 to lock in the spring

5. The communications jack of claim 4 wherein the spring 32 further comprises a diagonal cross leg 33.

6. The communications jack of claim 5 wherein the spring 32 further comprises a loop 41 configured to be captured by a boss feature 34 on the rotatable shutter door 28.
